(19) United States
(12) Patent Application Publication
(10) Pub. No.: US 2026/0094826 A1
(43) Pub. Date: Apr. 2, 2026

(54) NANO-ENGINEERED BATTERY ACTIVE MATERIAL POWDERS WITH FUNCTIONALLY GRADED MICROSTRUCTURE AND CONFORMAL COATINGS

(71) Applicant: NantG Power, LLC, El Segundo, CA (US)

(72) Inventors: Fabio ALBANO, El Segundo, CA (US); Nathan DUNLAP, El Segundo, CA (US); Taylor JURAN, El Segundo, CA (US); George BAURE, El Segundo, CA (US); Chun-Han LAI, El Segundo, CA (US); Eben PROSTAK, El Segundo, CA (US); Daniel ROBERTSON, El Segundo, CA (US); Patrick SOON-SHIONG, El Segundo, CA (US)

(21) Appl. No.: 19/287,521

(22) Filed: Jul. 31, 2025

Related U.S. Application Data
(60) Provisional application No. 63/678,010, filed on Jul. 31, 2024.

(51) Int. Cl. H01M 4/58; H01M 4/02; H01M 4/131; H01M 4/36; H01M 4/62; H01M 10/0525

(52) U.S. Cl. CPC H01M 4/5825; H01M 4/131; H01M 4/366; H01M 4/625; H01M 4/628; H01M 10/0525; H01M 2004/028

(57) ABSTRACT

An LMFP particle is disclosed, the LMFP particle comprising active material decorated with an engineered coating material, the coating material comprising at least one material selected from a group comprising: ionic compounds of V5+; Mg2+; Ti4+; Zr4+; Nb5+; W6+; Cr6+; Mo6+; Al₂O₃; ZrOₓ; TiO2; Nb₂O₅; and WO₃, and encapsulated in conductive carbon material; and binding material. An LMFP cathode is also disclosed, the LMFP cathode comprising active material, conductive carbon material; and engineered coating material decorated on the surface of the active material, the. A method for forming the engineered coating material is also disclosed.

### CROSS-REFERENCE TO RELATED PATENT APPLICATION

This application claims the benefit of U.S. Provisional Application No. 63/678,010, filed Jul. 31, 2024, entitled “Nano-Engineered Battery Active Material Powders with Functionally Graded Microstructure and Conformal Coatings,” the entirety of which is incorporated by reference herein.

### FIELD

Apparatuses and methods consistent with the present disclosure relate generally to energy storage systems, specifically, batteries. More specifically, they relate to lithium manganese iron phosphate batteries having an engineered thin coating on the surface of active material particles or on one or more electrodes.

### BACKGROUND

Olivine cathode materials (e.g., lithium manganese iron phosphate (“LMFP”)) have attracted interest due to their cost-effective manufacturing processes and performance comparable to known nickel manganese cobalt (“NMC”) Lithium-ion materials. Olivine-based cathode active materials are relatively less expensive, and do not rely on rare earth metals or elements such as cobalt, which are relatively scarce in North America.

In applications where energy and power densities are valued, layered transition metal oxides, e.g., NMC (LiNiₓMn_{y}CO_{1-x-y}O₂), are preferred cathode active materials. Yet, NMC synthesis is complex and relies on materials such as Co that are not naturally abundant in North America. Olivine cathode materials have attracted substantial interest due to their cost-effective manufacturing processes, use of non-Co elements, and performance benefits relative to known NMC cathode materials.

Olivine cathode material, e.g., LFP (LiFePO₄), has demonstrated potential as an alternative to NMC. Its robust phosphate polyanion crystal structure offers substantial safety, cycle-and calendar-life advantages over NMC, which is inherently unstable in a charged state. However, LFP's relatively low specific capacity (˜160 mAh/g—LFP vs. ˜190 mAh/g—NMC) and flat, two-phase (Fe²⁺-Fe³⁺) reaction potential (˜3.4 V—LFP vs. ˜3.7 V—NMC), limit achievable energy densities (˜530 Wh/kg—LFP vs. ˜700 Wh/kg—NMC). What is needed is a phosphate-based cathode material providing improved performance over current commercially available LFP materials.

A potential solution is a LiGe₁₋ₓMnₓPO4 (LMFP) battery. LMFP operates by two distinct redox processes; Fe²⁺-Fe³⁺ at 3.5V and Mn²⁺-Mn³⁺ at 4.1V, bringing its average working potential up to ˜4.0 V vs. Li. With a theoretical specific capacity approximately equal to that of LFP (˜160 mAh/g), this increased operating potential increases LMFP's energy density to over 600 Wh/kg-substantially higher than that of LFP (530 Wh/kg), and almost approaching that of SOA NMC (700 Wh/kg).

Yet, LMFP has not been widely accepted by the industry due primarily to certain shortcomings:
Low electrical conductivity (˜10⁻¹³ S/cm—LMFP vs. ˜10⁻⁹ S/cm—LFP)
Low Li-ion diffusivity (˜10⁻¹⁵ cm²/s—LMFP vs. ˜10⁻¹⁴ cm²/s—LFP)
Capacity fading due to transition metal (TM), i.e. Mn & Fe, dissolution into the electrolytes.
   These disadvantages have discouraged the use of LMFP as active cathode materials.

In addition to the disadvantages described above, which are described in more detail in the comparative examples below, LMFP cathodes are also sensitive to water and even trace amounts of moisture present in ambient air. Currently available solutions to the moisture issue involve coating the LMFP cathodes in a slurry, which typically requires toxic solvent N-methyl pyrrolidone (NMP). At scale, using NMP increases manufacturing costs due to the need for waste management and solvent recycling systems.

Currently, to avoid moisture adhering to the LMFP powders, coating must occur in a dry room, which further increases the cost of the cathode.

The various embodiments and examples discussed in this disclosure seek to improve energy density and decrease sensitivity to moisture for LMFP active cathode materials.

### SUMMARY

Embodiments of the present disclosure comprise an LMFP cathode, the LMFP cathode comprising active material encapsulated in conductive carbon material; and binding material.

Additional embodiments of the present disclosure comprise an LMFP cathode, the LMFP cathode comprising active material, conductive carbon material, and engineered coating material decorated on a surface of the active material, the engineered coating material comprising at least one material selected from a group comprising: ionic compound of V5+; Mg2+; Ti4+; Zr4+; Nb5+; W6+; Cr6+; Mo6+; and Al₃2O₃; ZrOₓ; TiO₂; Nb₂O₅; and WO₃.

Alternative embodiments provide a method for forming an engineered coating layer on LMFP-active cathode material, the method comprising determining one or more materials to be used for the engineered coating layer, and decorating the engineered coating material on an LMFP active material particle surface, the engineered coating layer comprising at least one material selected from a group comprising: ionic compounds of V5+; Mg2+; Ti4+; Zr4+; Nb5+; W6+; Cr6+; Mo6+; Al₂O₃; ZrOₓ; TiO₂; Nb₂O₅; and WO₃.

Additional alternative embodiments comprise at least one battery cell, further comprising an anode comprising a current collector and an electrochemically active material, LMFP cathode comprising a current collector, electrochemically active material comprising conductive carbon, binding material, an ionically conductive separator between the anode and the cathode, and electrolyte configured to provide ionic transfer between the anode and the cathode.

### BRIEF DESCRIPTION OF FIGURES

The accompanying drawings, which are incorporated in and constitute a part of this specification, illustrate some disclosed embodiments and, together with the description, serve to explain the disclosed embodiments. The particulars shown are by way of example and for purposes of illustrative discussion of embodiments of the present disclosure. The description taken with the drawings makes apparent to those skilled in the art how embodiments of the present disclosure may be practiced.

FIG. 1 is a flow chart illustrating a method for forming an engineered coating layer on an active material LMFP cathode, consistent with disclosed embodiments.

FIG. 2 is a schematic diagram illustrating an LMFP cathode encapsulated with graphene, consistent with disclosed embodiments.

FIG. 3 is a schematic diagram illustrating an exemplary LMFP battery, consistent with one or more embodiments of the present disclosure.

FIG. 4A is a schematic diagram illustrating an exemplary method of cathode materials synthesis using flame spray pyrolysis, consistent with disclosed embodiments.

FIG. 4B contains photos illustrating exemplary cathode nanoparticles produced using flame spray pyrolysis, consistent with disclosed embodiments.

FIG. 5 is a schematic diagram illustrating an exemplary method of analyzing LMFP cathode structures, consistent with disclosed embodiments.

FIG. 6 is a plot illustrating galvanostatic charge and discharge curves using known LMFP active cathode material.

FIG. 7 is a plot of reversible capacity cycling results using a commercially available baseline LMFP cathode.

FIG. 8 is a plot illustrating galvanostatic charge and discharge curves for an exemplary baseline LMFP cathode.

FIG. 9 is a plot of reversible capacity cycling results for an exemplary baseline LMFP cathode.

FIG. 10 is a plot illustrating galvanostatic charge and discharge curves for an exemplary LMFP cathode that is not encapsulated with graphene.

FIG. 11 is a plot illustrating galvanostatic charge and discharge curves for an exemplary LMFP cathode encapsulated with graphene.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements, unless otherwise represented. The exemplary embodiments in the following description do not represent all implementations consistent with the present disclosure. Instead, they are merely examples of systems, apparatuses, and methods consistent with aspects of the present disclosure, as recited in the appended claims.

Embodiments of the present disclosure improve energy density, functional safety, power density, and/or performance at low temperatures.

Embodiments comprise an LMFP cathode. LMFP refers to the active material in a battery, lithium manganese iron phosphate. Cathode refers to an electrode from which, on discharge, current leaves a battery and conventionally is designated as the positive electrode. Anode refers to an electrode, on discharge, through which current enters a battery, and is usually designated as the negative electrode.

Active material refers to one or more chemical substances that facilitate electrochemical reactions between anode and cathode to store and release electrical energy. The active material may differ between different types of batteries. As disclosed herein, active cathode material in an LMFP battery is lithium manganese iron phosphate.

In some embodiments, an LMFP cathode comprises conductive carbon material. Conductive carbon material is used to facilitate electrochemical reaction in a battery, as it improves electrical conductivity in electrodes, i.e., anode and cathode. Among different carbon materials, graphene is widely used in batteries because it offers high conductivity, mechanical strength, and flexibility. Consistent with disclosed embodiments, graphite may also be used as conductive carbon material. Conductive carbon material may be monolayered, multilayered, or comprise a network of graphene or other carbon allotropes. An allotrope refers to one of two or more different physical forms in which an element, such as carbon can exist. Allotropes have the same chemical composition but differ in the arrangement of those atoms, resulting in distinct physical and chemical properties. Graphene and graphite are exemplary carbon allotropes.

Embodiments of the present disclosure comprise an engineered coating material formed, either fully or partially, decorating the surface of active cathode material. Not being bound by theory, the engineered coating material of the present disclosure is used to stabilize the electrochemical reaction occurring within a battery, improve electrical conductivity, improve cycling performance, and/or prevent undesired surface reactions. Consistent with disclosed embodiments, non-limiting exemplary coating materials include: ionic compounds of V5+; Mg2+; Ti4+; Zr4+; Nb5+; W6+; Cr6+; Mo6+; Al₂O₃; ZrOₓ; TiO₂; Nb₂O₅; WO₃; and/or conductive carbon. The decorated active materials coatings may comprise one of these materials, or a mixture of one or more of these materials.

In some embodiments, coating material is decorated on surface of the active material particles, at least partially covering the surface of the active material. The coating material may cover up to 10% of the surface of the active material, up to 25% of the surface of the active material, up to 50% of the surface of the active material, up to 75% of the surface of the active material, or up to 90% of the surface of the active material.

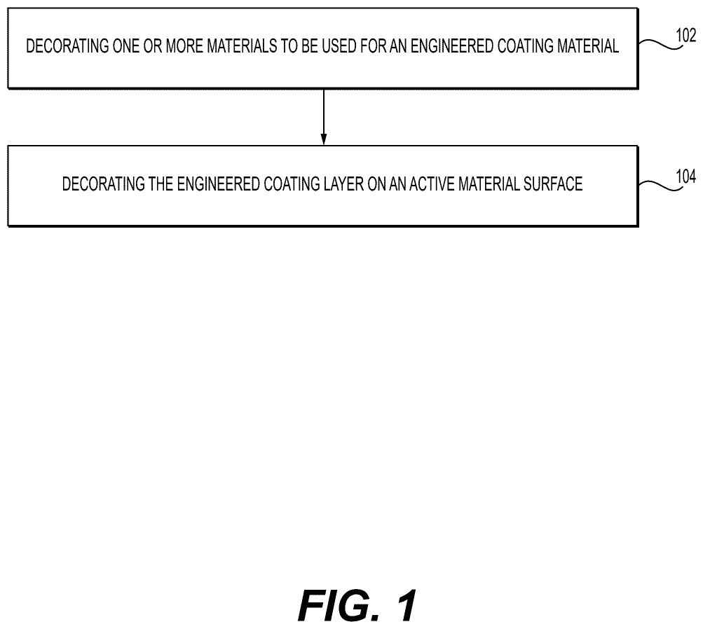

FIG. 1 is a flow chart illustrating a method for forming an engineered coating layer on an active material LMFP cathode, consistent with disclosed embodiments.

As depicted in FIG. 1, method 100 includes step 102 of determining one or more materials to be used for engineered coating material from a plurality of candidate materials. Consistent with this disclosure, candidate materials comprise at least one of: V5+; Mg2+; Ti4+; Zr4+; Nb5+; W6+; Cr6+; Mo6+; Al₃2O₃; ZrOₓ; TiO₂; Nb₂O₅,; and WO₃.

Method 100 includes step 104 of decorating the engineered coating layer on an active material surface. Active materials may, in a non-limiting example, comprise olivine cathodes, layered oxide cathodes, and/or spinel structure cathodes. Conductive carbon material may be added to active material as electronically conductive additives. In a non-limiting example, these can comprise carbon nanotubes, carbon nanoparticles, carbon black, carbon fiber, graphite, graphene, and combinations thereof. These materials are generally referred to as conductive additives.

If desired, the degree of coverage of the coating decorated on the surface of the active material particles may be determined using known methods, such as microscale thermogravimetric analysis (u-TGA), or transmission electron microscopy (TEM), or atomic force microscopy (AFM).

In one or more embodiments, coating material is formed using atomic layer deposition (ALD). ALD refers to a thin film fabrication process during which vapor phase precursors are separately and sequentially introduced to a cathode surface. Precursors are compounds that participate in chemical reactions that produce other compounds. In some embodiments, precursors include lithium, manganese, and/or iron phosphate. Each precursor that reacts with the cathode surface changes the surface functionality to a new functionality that will be reactive with the next precursor in the reaction cycle.

Reaction cycle refers to how the precursor material is deposited on the cathode surface. Each reaction cycle generally includes an exposure step and a purge step, wherein the exposure step involves exposing the cathode surface to a precursor and the purge step involves the precursor evacuating the reaction chamber. The reaction cycle is generally split into two (or three) half-reactions and alternated cyclically in an A-B-A-B-sequence, where one reaction cycle is a complete A-B process.

Consistent with disclosed embodiments, each reaction is designed to be self-limiting so that the gas-surface reaction stops when all desired cathode surface sites are converted. Each reaction cycle produces a monolayer of coating that covers topographical contours of surface that are reactive to gaseous precursors. The reaction sequence is repeated until the desired thickness of coating is reached. The self-limiting and cyclic nature of the ALD process makes it superior in thickness and chemical precision relative to other thin-film fabrication techniques.

Some embodiments comprise ALD coatings selected from a group comprising Al₂O₃; ZrOₓ; TiO₂; Nb₂O₅; and WO₃. Over time, LMFP cathode materials—mainly Mn^{x+} & Fe^{x+}, generally referred to as transition metal ions—break down in the battery's electrolyte. This phenomenon is generally known as transition metal dissolution and may be initiated by irreversible phase transformations driven by disproportionation and Jahn-Teller distortion.

While conformal contact with the electrolyte is necessary for facile de/lithiation of the LMFP active particles, acidic species in the electrolyte, i.e., hydrofluoric acid (HF), can attack unstable phases and defects on the LMFP particles'surface, resulting in rapid transition metal dissolution. This then triggers additional irreversible structural transformations, culminating in a cascading cycle of cathode active material damage, irreversible capacity loss and rise in resistance. The exemplary ALD coatings disclosed herein may stabilize and shield cathode surface structures otherwise prone to transitional metal dissolution.

The method disclosed and claimed of forming a thin film is not limited to ALD. Other deposition methods may also be used, including, without limitation, physical vapor deposition (PVD), molecular layer deposition (MLD), chemical vapor deposition (CVD), vapor phase epitaxy (VPE), and/or atomic layer chemical vapor deposition (ALCVD).

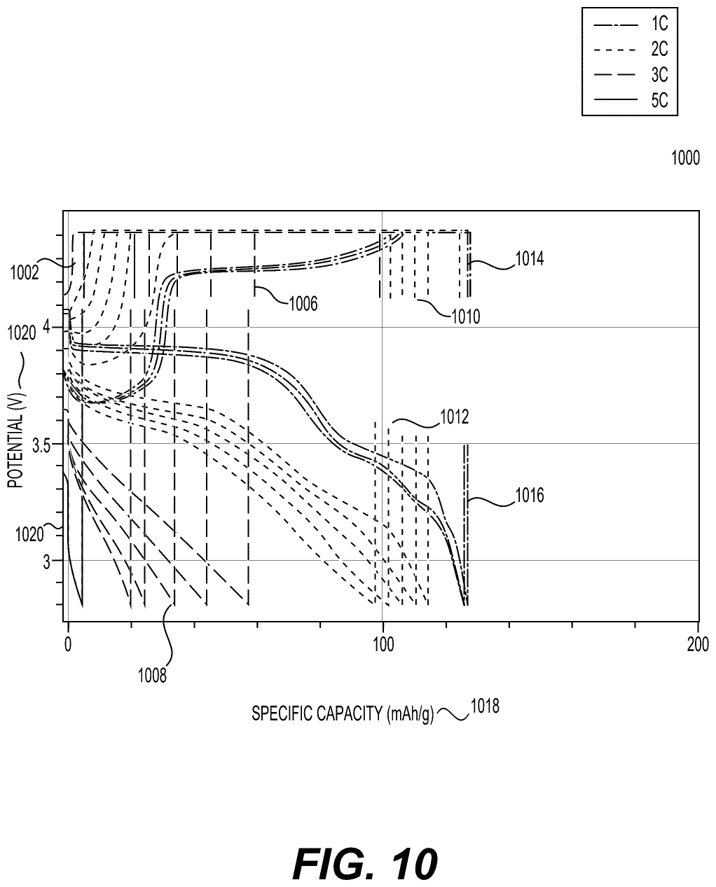

In some embodiments, the coating material is formed by doping. Doping refers to the intentional introduction of impurities into a cathode for the purpose of modulating its electrical properties. Doping may enhance structural stability, increase capacity retention, and/or improve resistance to thermal runaway. In some embodiments, potential dopants include V5+; Mg2+; Ti4+; Zr4+; Nb5+; W6+; Cr6+; and/or Mo6+. Substituting dopant ions for a small fractions of Mn & Fe sites, in some embodiments, y=0-0.04 in LiFe_{1-x-y}MnₓM_{y}PO₄, M=W, Ti, Al, etc., of dissimilar valence and electron configuration, increases LMFP's charge carrier concentration and decrease its band gap, improving conductivity and performance, as shown in FIG. 10.

Not wishing to be bound by theory, the inventors believe embedding carbon within and between doped LMFP particles may promote facile charge transfer reactions (i.e., easy and efficiency movement of electrical charges) and fast cycling rates with minimal polarization or active material isolation, enabling thick and energy-dense electrodes.

Consistent with disclosed embodiments, strategic cation doping may also help improve Li-ion diffusivity through LMFP crystal structure. Incorporating dopant ions throughout the structure may expand pathways for Li-ion transport and reduce energy barriers to diffusion. Additionally, careful control of particle morphology (e.g. nano-platelets & core-shell) and crystallite orientation reduces Li-diffusion pathlengths while increasing tap densities and electrode loadings, as shown in FIG. 10. Depending on the desired performance of the battery, one or more dopants may be used.

In some embodiments, LMFP particles may also be prepared with predominant crystal plane orientation, which permits short and efficient Li+diffusion pathways along the b-axis.

In an embodiment, coating layer may be engineered as a relatively thin, substantially uniform, and substantially mechanically stable coating, decorated on the surface of active cathode material. In an embodiment, coating layer is engineered as discontinuous coating ranging between 10% to 90% of surface area of active materials particles.

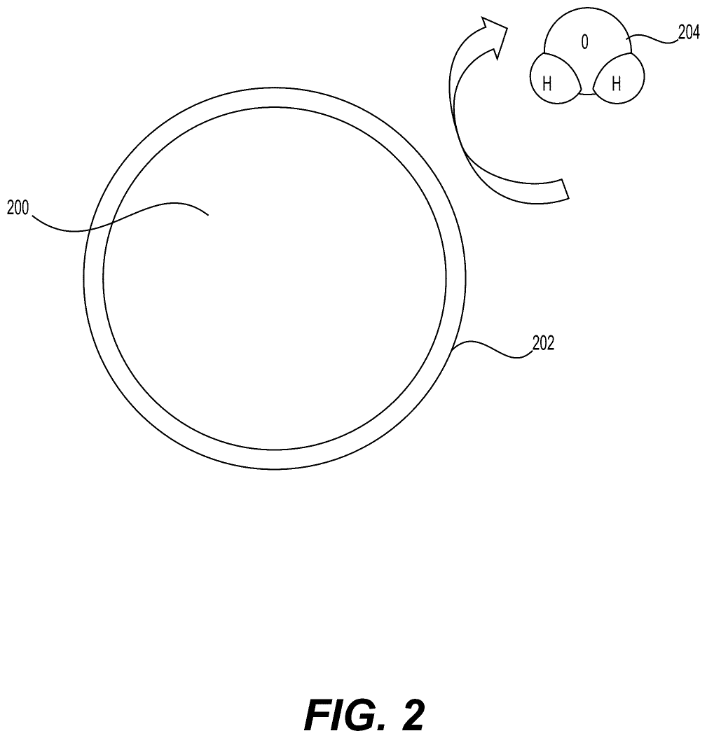

FIG. 2 is a schematic diagram illustrating an LMFP particle 200 encapsulated with a graphene coating 202, consistent with disclosed embodiments. As described elsewhere in this disclosure, graphene is a conductive carbon additive and is used to facilitate electron transport and decrease resistance throughout the cathode during battery operation. Among different carbon materials, graphene is widely used in batteries because it offers high conductivity, mechanical strength, and flexibility. In addition to these benefits, graphene coating 202 is hydrophobic, meaning that it inherently repels water 204, or relevant here, moisture in ambient air.

Graphene coating 202 also protects the cathode surface from the harsh chemical environment within the battery to enhance cycling stability and preserve long cycle life.

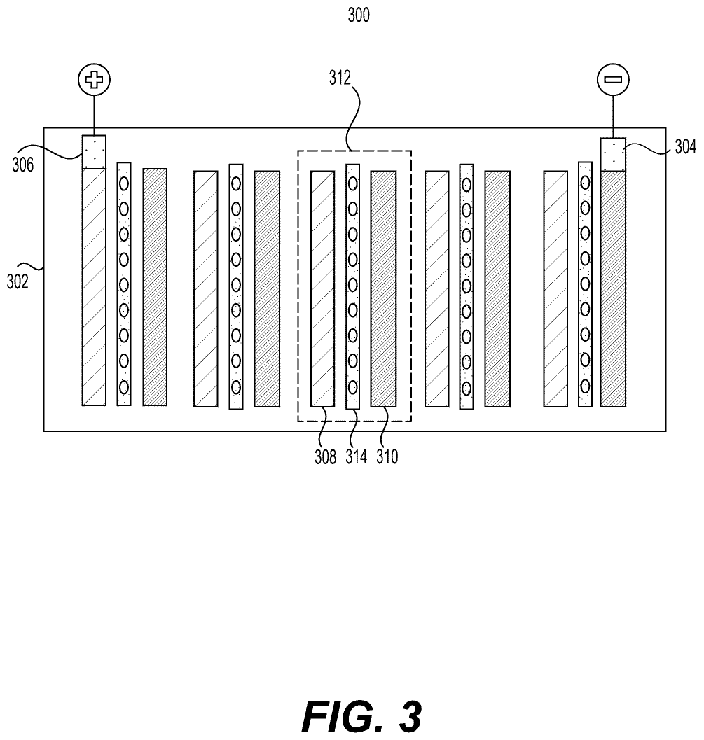

FIG. 3 is a schematic diagram illustrating an exemplary LMFP battery 300, consistent with disclosed embodiments. LMFP battery 300 may include casing 302 having positive terminal 304 and negative terminal 306. As depicted in FIG. 3, at least one anode 308, cathode 310, and separator 314 may be disposed within casing 302. In some embodiments, LMFP battery 300 may contain engineered coating disposed on active material present in anode 308 and/or cathode 310.

LMFP battery 300 may include a plurality of battery cells, in some embodiments, five battery cells, as shown in FIG. 3. Any number of battery cells can be used. As shown in FIG. 3, battery cell 312 includes anode 308, cathode 310, and separator 314. In one or more embodiments, anode 308 may include metal foil as a current collector. Metal foil may be copper, nickel, titanium, or any other suitable metal foil.

In one or more embodiments, anode 308 may include: an oxidizable metal (e.g., lithium); material capable of intercalating the oxidizable metal (e.g., graphite or silicon); electrolyte; a binder (e.g., polyethylene oxide, polyacrylonitrile, polyvinylidene fluoride, or polyvinylidene fluoride-hexafluoropropylene); and electronically conductive additive (e.g., carbon black, graphite, or graphene). In one or more embodiments, anode 308 may also include ionically conductive materials. In another embodiment, anode comprises graphite.

Consistent with this disclosure, binder or binding material refers to material used to ensure contact between the active material and the conductive additives, and anchors those materials to the current collector.

In one or more embodiments, cathode 310 comprises metal foil as a current collector such as aluminum, titanium, nickel, or nickel foil. In some embodiments, cathode 310 comprises lithium, manganese, and iron phosphate. Cathode 310 may include conductive carbon. Active materials may comprise but are not limited to olivine cathodes, layered oxide cathodes and spinel cathodes. Conductive carbon material may comprise, for example, carbon nanotubes, carbon nanoparticles, carbon black, carbon fiber, graphite, graphene, and/or combinations thereof.

In some embodiments, cathode comprises, by weight, at least 90% active material (here, LMFP), between 1% and 5% conductive material (e.g., graphite and/or graphene), and between 1% and 5% binding material (e.g., PVdF binders).

In some embodiments, cathode 310 is formed via flame spray pyrolysis. Flame spray pyrolysis (“FSP”) refers to a method of producing metal oxide powders from highly volatile gaseous metal chlorides oxidized in hydrogen-oxygen flames to form nano-oxide powders. Flame spray pyrolysis may be used to produce high-purity, low-cost, nano-particles. FSP may be used to assess LMFP powder properties including, but not limited to, morphology, particle size, carbon contents, and/or dopants. FSP is also used to prepare structures that are not feasible using other cathode forming methods, because FSP produces uniform mixing among components, void space control, and unique microsphere morphologies consisting of networked secondary microparticles composed of nanostructured primary particles. FSP is further used to overcome intrinsic material limitations (i.e. low Li+ diffusion & electrical conductivity) while maximizing powder, slurry, and electrode properties (e.g. tap density, solids content, rheology, and energy density).

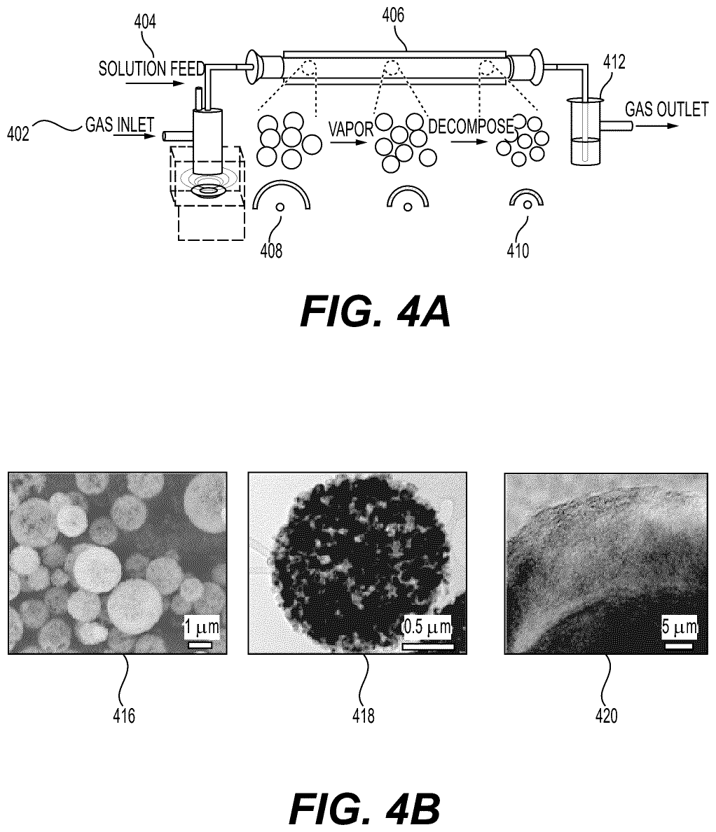

FIG. 4A is a schematic diagram illustrating an exemplary method of cathode material synthesis using flame spray pyrolysis, consistent with disclosed embodiments. Gas, typically oxygen, enters gas inlet 402, and mixes with precursor solution 404. Precursor solution comprises at least one of lithium, iron phosphate, and/or manganese. Oxygen-precursor mix enters combustion chamber 406. Oxygen-precursor mix vaporizes 408, quickly condensing as nanoparticles 410 as temperature cools over length of combustion chamber 406. Oxygen exits system via gas outlet 412, leaving behind finely tuned nanopowders, which are ready to be synthesized into cathode.

FIG. 4B contains photos illustrating exemplary cathode nanoparticles produced using flame spray pyrolysis, consistent with disclosed embodiments. View 416 shows particle distance from other particles at a scall of 1 micrometer. Zoomed view 418 shows the nanoparticle at a 0.5 micrometer scale. Further zoomed in view 420 shows the nanoparticle at a 5 nm scale.

In some embodiments, cathode 310 is formed via solid state synthesis. Solid state synthesis refers to a method of producing nanoparticles by managing composition and reducing particle size using at least one mechanical procedure, such as ball milling. Ball milling is a method that grinds to fine powders. Consistent with disclosed embodiments, solid-state synthesis may be used to obtain pure, pristine, nano-spheres or nano-platelets of active materials. Active materials are then coated using ALD. Not being bound by theory, consistent with this disclosure, reduced particle size (nano-particles) may permit shorter ionic conduction pathways, thereby improving battery performance.

In some embodiments, cathode 310 is formed via hydrothermal synthesis. Hydrothermal synthesis refers to a method of fabricating battery materials, typically involving crystallizing substances (e.g., the precursor ingredient which will eventually become the cathode) from high-temperature aqueous solutions at high vapor pressures. Consistent with disclosed embodiments, one may use hydrothermal synthesis to obtain pure, pristine, nano-spheres or nano-platelets of active materials, wherein the active materials are then coated using ALD. Consistent with disclosed embodiments, FSP, solid state synthesis, and hydrothermal synthesis may be used to form anode as well as cathode.

In one or more embodiments, separator 314 may be ionically conductive material, such as porous polymer (e.g., polyolefins), polymer electrolyte (e.g., polystyrene-polyethylene oxide (PS-PEO)), ceramic (e.g., lithium phosphorous oxynitride (LiPON), lithium aluminum titanium phosphate (LATP), or lithium aluminum germanium phosphate (LAGP)), and/or 2-dimensional sheet structures (e.g., graphene, boron nitride, or dichalcogenides).

In some embodiments, electrolyte is provided to facilitate ion transfer between anode and cathode. Electrolyte may be solid or liquid, and may be configured to facilitate the electrochemical reaction in exemplary LMFP battery 300. Electrolyte facilitates solid to liquid conversion reactions. Weight of the electrolyte may be reduced by reducing cathode porosity.

Consistent with disclosed embodiments, electrolyte comprises at least one of LITFSI, LIBOB, and EC:DMC. Electrolyte may comprise only one of these compounds, or may be a mixture of one or more of the compounds. In a preferred embodiment, electrolyte comprises 1M LiPF₆ in 1:1:1 vol. EC:EMC:DMC+2 wt % VC.

Persons of ordinary skill may find it desirable to analyze one or more characteristics of LMFP cathode. Limitations in LMFP cathode performance may be attributed to processes within active particles and at interfaces with electrolyte solution. Irreversible bulk structural changes or phase transitions during charge and discharge processes may lead to accumulated mechanical stress due to lattice mismatches, eventually causing cathode cracking and performance degradation.

Cathode surface is particularly vulnerable to changes in chemical composition and crystal structure induced by side reactions with the electrolyte, forming cathode/electrolyte interphase (CEI). Metal dissolution from cathode surface, exacerbated at high states of charge and elevated temperatures, results in increased impedance during cycling. Monitoring structural stability of cathode materials, particularly complex and heterogeneous CEI chemistry at the sub-nanometer scale, may be desirable for developing advanced LMFP cathodes with rationally designed low-impedance interfaces.

In analyzing LMFP cathode structure it may be desirable to employ one or more of X-ray diffraction (XRD), scanning electron microscopy (SEM), UV-vis spectroscopy, Fourier transform infrared spectroscopy (FT-IR), Raman spectroscopy, as well as advanced techniques available only at synchrotron facilities such as the Advanced Light Source at LBNL and the Stanford Synchrotron Radiation Lightsource (SSRL).

Multiple techniques may be used to observe the LMFP cathode crystal structure. For example, XRD permits observation of dynamic changes of LMFP crystal structure during cycling (i.e., switching between the charging and discharging states), which provides information pertaining to structural stability and cell failure mechanisms. X-ray absorption spectroscopy (XAS) may be used to observe changes in chemical states and local coordination environments of the transition metals (i.e., Mn and Fe) in LMFP cathodes during charge and discharge. Transmission X-ray microscopy (TXM) may be used to capture transmission X-ray images, providing information on state-of-charge distribution and chemical state distribution across a cathode particle. Transmission electron microscopy (TEM) may be used to characterize crystal structure and elemental distribution to gain further structural and chemical information on LMFP materials. Combining these techniques may allow for characterization of LMFP cathode materials across a wide length scale from the bulk to the surface, thereby aiding in observing and overcoming LMFP failure mechanisms.

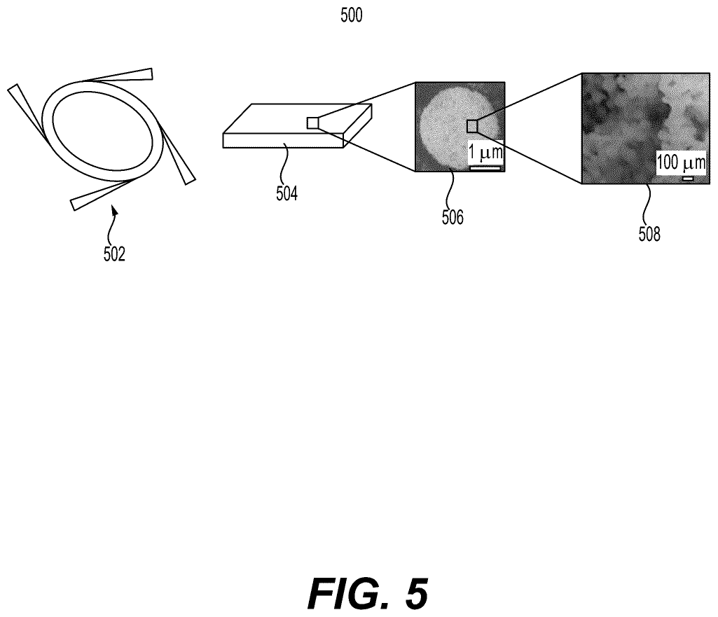

FIG. 5 is a schematic diagram illustrating an exemplary method of analyzing LMFP cathode structures. Synchrotron XRD 502 is used to analyze LMFP cathode crystal structure 504, providing information on structural stability and cell failure mechanisms. Synchrotron XRD 502 may be used to analyze LMFP cathode crystal structure 504 at the micrometer level and the nanometer level. At the micrometer level, secondary microparticles particles 506 may be observed. At the nanometer level, primary nanoparticles 508 may be observed. Secondary microparticles 506 and primary nanoparticles 508 refer to cathode material sizes. Producing primary nanoparticles 508 may at least improve energy density and battery performance, consistent with disclosed embodiments.

### Comparative Example 1

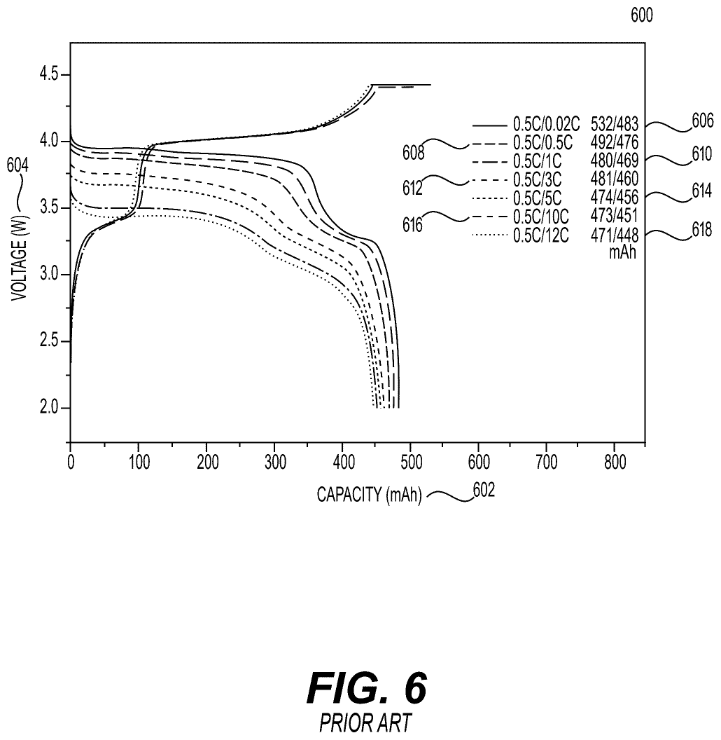

Some disadvantages observed in the prior art are depicted in FIG. 6, which are galvanostatic charge/discharge curves 606 to 618 of the performance of exemplary, known, baseline LMFP active cathode materials that do not include the inventive features of the present invention. The present inventors believe that the present invention offers substantial opportunities to substantially improve the performance of LMFP active cathode materials. Specifically, the baseline LMFP active cathode material depicted in FIG. 6, does not comprise coatings (ALD or otherwise), nor does it comprise cation doping. The present inventors believe that these and other features of the present disclosure offer the opportunity to substantially improve the performance of LMFP active cathode material.

In this example, referring to FIG. 6, baseline LMFP battery typically comprises 93% by weight lithium manganese iron phosphate (LMFP), 3% by weight conductive additives, here, graphene nanoplatelets, and 4% by weight polyvinylidene fluoride (PVdF) binder. In this example, the x-axis 602 illustrates the baseline LMFP battery's capacity in milliampere-hours, and y-axis 604 illustrates the measured voltage in volts. Voltage may also be measured in millivolts. The same electrode formulation was used for each example described herein.

In this example, galvanostatic charge/discharge curve 606 has a charge rate of 0.5 C and a discharge rate of 0.2 C. meaning that the battery charges over a two-hour period and discharges over a five-hour period. In this example, the charge capacity is 532 mAh, and the discharge capacity is 483 mAh.

### Comparative Example 2

In this example, referring to FIG. 6, galvanostatic charge/discharge curve 608 has a charge rate of 0.5 C and a discharge rate 0.5 C, meaning that the battery charges over a two-hour period and discharges over a two-hour period. In this example, the battery has a charge capacity of 492 mAh, and a discharge capacity of 476 mAh.

### Comparative Example 3

In this example, referring to FIG. 6, galvanostatic charge/discharge curve 610 has a charge rate of 0.5 C and a discharge rate of 1 C, meaning that the battery charges over a two-hour period and discharges over a one-hour period. In this example, the battery has a charge capacity of 480 mAh and a discharge capacity of 469 mAh.

### Comparative Example 4

In this example, referring to FIG. 6, galvanostatic charge/discharge curve 612 has a charge rate of 0.5 C and a discharge rate of 3 C, meaning that the battery charges over a two-hour period and discharges over a 20-minute period. In this example, the battery has a charge capacity of 481 mAh and a discharge capacity of 460 mAh.

### Comparative Example 5

In this example, referring to FIG. 6, galvanostatic charge/discharge curve 614 has a charge rate of 0.5 C and a discharge rate of 5 C, meaning that the battery charges over a two-hour period and discharges over a 12-minute period. In this example, the battery has a charge capacity of 474 mAh and a discharge capacity of 451 mAh.

### Comparative Example 6

In this example, and referring to FIG. 6, galvanostatic charge/discharge curve 616 has a charge rate of 0.5 C and discharge rate of 10 C, meaning that the battery charges over a two-hour period and discharges over a 6-minute period. In this example, the battery has a charge capacity of 473 mAh and a discharge capacity of 451 mAh.

### Comparative Example 7

In another example, galvanostatic charge/discharge curve 618 has a charge rate of 0.5 C and a discharge rate of 12 C, meaning that the battery charges over a two-hour period and discharges over a five-minute period. In this example, the battery has a charge capacity of 471 mAh and a discharge capacity of 448 mAh.

### Comparative Example 8

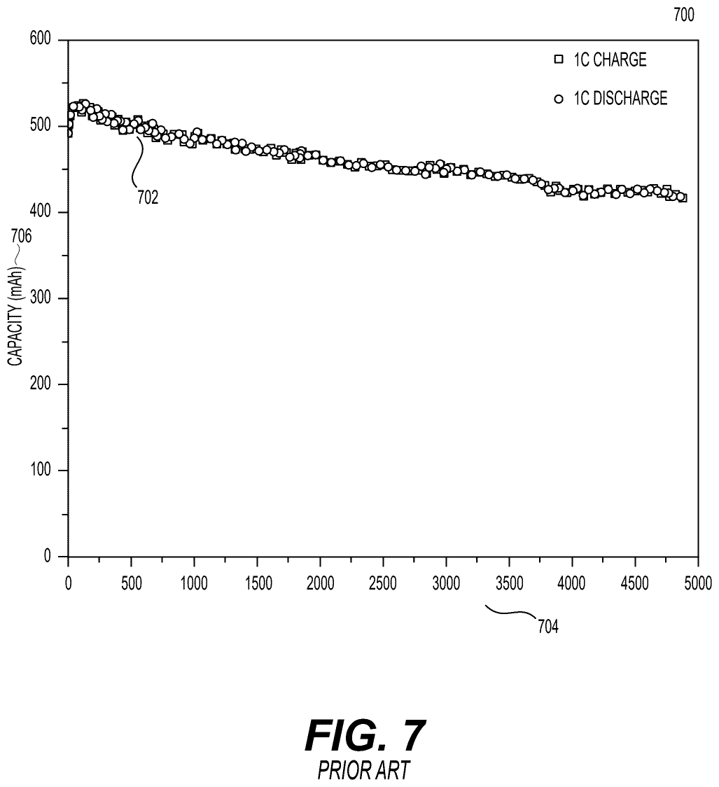

FIG. 7 is a plot 700 illustrating reversible capacity cycling results 702 in exemplary, commercially available LMFP active cathode material. The x-axis 704 in FIG. 7 corresponds to the number of cycles, i.e., where the baseline LMFP battery 300 is fully charged and fully discharged. The y-axis 706 corresponds to the baseline LMFP battery's storage capacity. In this example, stable 80% swing cycling at 1 C in a 0.5 Ah pouch cell was observed over 5,000 cycles. Measuring 5,000 cycles of a single battery typically takes months or years. Pouch cells generally refer to batteries with a flexible, multilayered laminate structure comprising an anode, a cathode, and a separator. Here, the baseline LMFP battery maintained 80% of its original charge capacity over 5,000 cycles.

In this example, reversible capacity cycling results 702 show that, at 0 cycles, the prior art baseline LMFP battery has a storage capacity of approximately 500 mAh. At 2500 cycles, the baseline LMFP battery has a storage capacity of approximately 450 mAh. At 5000 cycles, the prior art baseline LMFP battery has a storage capacity of approximately 400 mAh.

In this example, the results 702 depicted in FIG. 7, were obtained using an uncoated and undoped LMFP cathode. The baseline LMFP cathode contained a cathode loading of approximately 11 mg/cm². Specifically, the baseline LMFP cathode comprised approximately 11 mg of active material per square cm. In this example, the baseline LMFP cathode provided an energy density of approximately 140 Wh per kg.

### Inventive Example 1

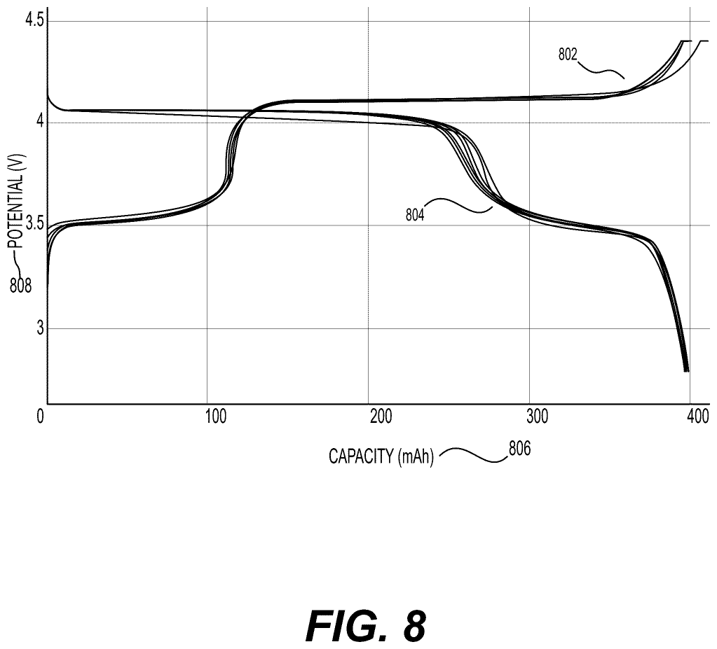

By way of example, FIG. 8 is a plot 800 illustrating galvanostatic charge curves 802 and discharge curves 804 using an exemplary baseline LMFP cathode 310. In this example, x-axis 706 illustrates the baseline LMFP battery's capacity in milliampere-hours (mAh), ranging from 0 to 4 mAh, and y-axis 808 illustrates the measured voltage in volts (V), using a voltage window of between 0 and 4.5V. Voltage may also be measured in millivolts. The same electrode formulation was used for each example described herein.

The results illustrated in FIG. 8 were achieved using a small cell (approximately 4 mAh) LMFP cathode, cycled at constant charge and discharge rate, C/10, meaning that LMFP cathode charged and was discharged over a ten-hour period each. Charge curve 802 illustrates that a voltage of 4.5V was measured after LMFP cathode was fully charged, and discharge curve 804 illustrates that a voltage of approximately 3V was measured after LMFP cathode was fully discharged.

### Inventive Example 2

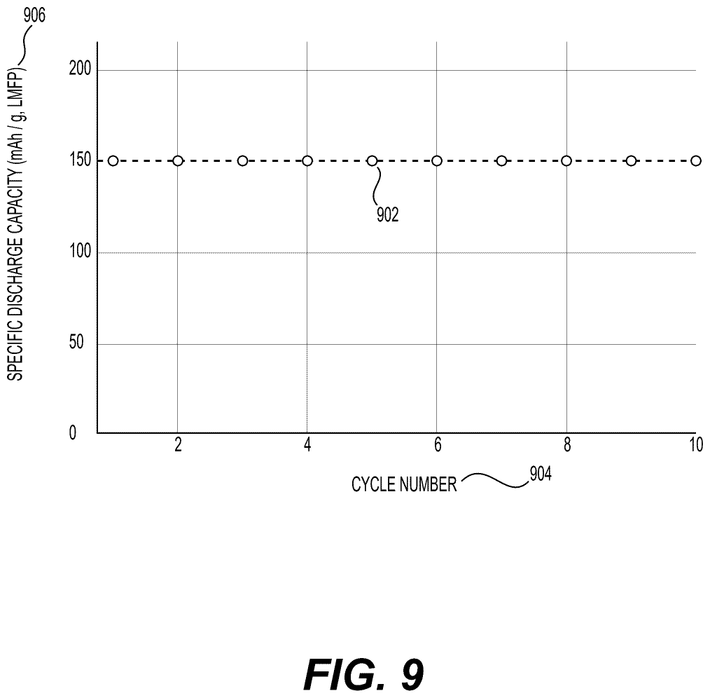

FIG. 9 is a plot 900 illustrating reversible capacity cycling results 902 using an exemplary baseline LMFP cathode. In this example, x-axis 902 corresponds to the number of cycles, i.e., wherein exemplary LMFP battery 500 is fully charged and fully discharged. Y-axis 904 corresponds to LMFP battery 500's specific discharge capacity, measured in mAh/g. Here, results 902 illustrate that LMFP battery 500's specific discharge capacity remains constant at 150 mAh/g over 10 cycles.

Consistent with disclosed embodiments, ionic and electronic conductivity may improve in cathode 310 in LMFP battery 300, for example, via doping, further reducing the deposited particle sizes, and adding ALD coatings. Exemplary doping cations include, but are not limited to: V5+; Mg2+; Ti4+; Zr4+; Nb5+; W6+; Cr6+; and/or Mo6+. Exemplary ALD coatings include, but are not limited to, Al₃2O₃, ZrOₓ, TiO₂, Nb₂O₅ and WO₃. Consistent with this disclosure, the exemplary doping cations and ALD coatings are collectively referred to as nano-particles.

In some embodiments, coating the baseline LMFP battery 300 with materials consistent with this present disclosure may further improve battery performance. For example, a coated LMFP battery may, relative to commercially available NCM battery, exhibit higher specific usable energy, a longer calendar life, more usable cycles, lower usage cost, shorter recharge time, faster charging times, more usable energy at lower temperatures, and a greater survival temperature range.

### Inventive Example 3

By way of example, FIG. 10 is a plot 1000 illustrating four sets of galvanostatic charge/discharge curves 1002-1016. The results illustrated in plot 1000 were obtained using an unencapsulated LMFP cathode. To obtain the results illustrated in FIG. 10, baseline LMFP cathode, such as, for example, cathode 310, was coated with a coating material as described and exemplified throughout this disclosure. In this example, cathode 310 was coated with Cr and Al₂O_{3.}

In this example, x-axis 1018 illustrates the baseline LMFP battery's specific capacity in milliampere-hours per gram (mAh/g), ranging from 0 to 200 mAh/g, and y-axis 1020 illustrates the measured voltage in volts (V), using a voltage window of between 0 and 4.5V. Voltage may also be measured in millivolts. The same electrode formulation was used for each example described herein.

In one example, galvanostatic charge/discharge curve 1002, 1004 has a charge/discharge rate of 5 C, meaning that the battery charges and discharges over a 12-minute period. Charge curve 1002 illustrates that a voltage of approximately 4.2 V and a specific capacity of between 10 and 25 mAh/g was measured after unencapsulated LMFP cathode was fully charged, and discharge curve 1004 illustrates that a voltage of approximately 4.1 V and a specific capacity of 10 mAh/g was measured after unencapsulated LMFP cathode was fully discharged.

In another example, galvanostatic charge/discharge curve 1006, 1008 has a charge/discharge rate of 3 C, meaning that the battery charges and discharges over a 20-minute period. Charge curve 1006 illustrates that a voltage of approximately 4.2 V and a specific capacity of between 10 and 100 mAh/g was measured after unencapsulated LMFP cathode was fully charged, and discharge curve 1008 illustrates that a voltage of approximately 4.1 V and a specific capacity of between 20 and 50 mAh/g was measured after unencapsulated LMFP cathode was fully discharged.

In another example, galvanostatic charge/discharge curve 1010, 1012 has a charge/discharge rate of 2 C, meaning that the battery charges and discharges over a 20-minute period. Charge curve 1010 illustrates that a voltage of approximately 4.2 V and a specific capacity of between 100 and 125 mAh/g was measured after unencapsulated LMFP cathode was fully charged, and discharge curve 1012 illustrates that a voltage of between approximately 3.5 and 3.6 V and a specific capacity of between 95 and 115 mAh/g was measured after unencapsulated LMFP cathode was fully discharged.

In yet another example, galvanostatic charge/discharge curve 1014, 1016 has a charge/discharge rate of 1 C, meaning that the battery charges and discharges over a one-hour period. Charge curve 1014 illustrates that a voltage of approximately 4.2 V and a specific capacity of approximately 125 mAh/g was measured after unencapsulated LMFP cathode was fully charged, and discharge curve 1016 illustrates that a voltage of approximately 3.5 V and a specific capacity of approximately 125 mAh/g was measured after unencapsulated LMFP cathode was fully discharged.

As illustrated in FIG. 10, applying the disclosed coatings and/or dopants improves energy density, functional safety, power density, and/or performance at low temperatures, compared to the baseline LMFP cathode charge curves depicted in FIG. 8.

### Inventive Example 4

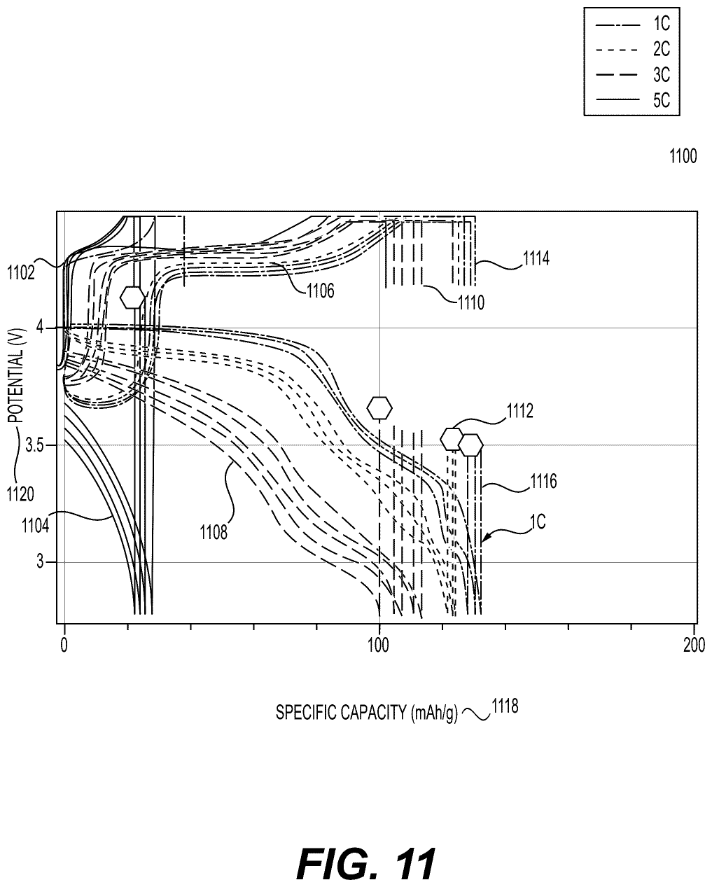

FIG. 11 is plot 1100 illustrating four sets of galvanostatic charge and discharge curves 1102-1116 for an exemplary LMFP cathode encapsulated with graphene, consistent with disclosed embodiments. LMFP cathode may contain LMFP particles encapsulated with graphene, as shown in FIG. 2. The data illustrated in FIG. 11 was obtained using the coated LMFP cathode described in reference to FIG. 10, which was then encapsulated in graphene.

In this example, x-axis 1118 illustrates the baseline LMFP battery's specific capacity in milliampere-hours per gram (mAh/g), ranging from 0 to 200 mAh/g, and y-axis 1120 illustrates the measured voltage in volts (V), using a voltage window of between 0 and 4.5V. Voltage may also be measured in millivolts. The same electrode formulation was used for each example described herein.

In one example, galvanostatic charge/discharge curve 1102, 1104 has a charge/discharge rate of 5 C. Charge curve 1102 illustrates that a voltage of approximately 4.2 V and a specific capacity of 25 mAh/g was measured after graphene-encapsulated LMFP cathode was fully charged, and discharge curve 1104 illustrates that a voltage of approximately 4.1 V and a specific capacity of 25 mAh/g was measured after graphene-encapsulated LMFP cathode was fully discharged.

In another example, galvanostatic charge/discharge curve 1106, 1008 has a charge/discharge rate of 3 C. Charge curve 1106 illustrates that a voltage of approximately 4.2 V and a specific capacity of between 90 and 110 mAh/g was measured after graphene-encapsulated LMFP cathode was fully charged, and discharge curve 1108 illustrates that a voltage of approximately 3.6 V and a specific capacity of between 90 and 110 mAh/g was measured after graphene-encapsulated LMFP cathode was fully discharged.

In another example, galvanostatic charge/discharge curve 1110, 1112 has a charge/discharge rate of 2 C. Charge curve 1110 illustrates that a voltage of approximately 4.2 V and a specific capacity of approximately 120 mAh/g was measured after graphene-encapsulated LMFP cathode was fully charged, and discharge curve 1112 illustrates that a voltage of approximately 3.5 V and a specific capacity of approximately 120 mAh/g was measured after graphene-encapsulated LMFP cathode was fully discharged.

In yet another example, galvanostatic charge/discharge curve 1114, 1116 has a charge/discharge rate of 1 C. Charge curve 1114 illustrates that a voltage of approximately 4.2 V and a specific capacity of approximately 130 mAh/g was measured after graphene-encapsulated LMFP cathode was fully charged, and discharge curve 1116 illustrates that a voltage of approximately 3.5 V and a specific capacity of approximately 130 mAh/g was measured after graphene-encapsulated LMFP cathode was fully discharged. Consistent with disclosed embodiments, encapsulating LMFP particles with graphene makes the data more consistent, reduces efficiency losses, and increases power capabilities at higher discharge rates (i.e., above 1 C).

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but, rather, “an illustration, instance, or example.” By reading this disclosure, including the description of the embodiments and the drawings, persons of ordinary skill will appreciate that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed and claimed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

1. A system comprising:
a memory storing instructions; and
at least one processor configured to execute the stored instructions to:
retrieve, from a first source, a first document;
retrieve, from a second source, a second document;
process the first document and the second document, wherein processing includes cleaning, tokenizing, and vectorizing the first document and the second document;
determine a cosine similarity between a first set of numbers and a second set of numbers, the first set of numbers corresponding to one or more sentences in the first document and the second set of numbers corresponding to one or more sentences in the second document, wherein each number in the first set of numbers corresponds to a word in the first document and each number in the second set of numbers corresponds to a word in the second document;
determine whether the cosine similarity exceeds a first threshold;
determine, based on the cosine similarity, a number of words in common between the first document and the second document;
determine whether the number of words in common exceeds a second threshold;
determine, based on the cosine similarity, a number of sentences in common between the first document and the second document;
determine whether the number of sentences in common exceeds a third threshold; and
responsive to a determination that the cosine similarity exceeds the first threshold, the number of words in common exceeds the second threshold, or the number of sentences in common exceeds the third threshold:
set a flag that indicates that the second document is a duplicate.

2. The system of claim 1, wherein the at least one processor is further configured to:
iterate the processing, determining, and flag setting steps for each of a plurality of documents retrieved from the second source, until the second source no longer contains any documents to process.

3. The system of claim 2, wherein the at least one processor is further configured to provide for display, on a graphical user interface, a number of set flags.

4. The system of claim 1, wherein the first source includes repository of previously submitted documents.

5. The system of claim 1, wherein the second source includes repository of newly submitted documents.

6. The system of claim 1, wherein processing further includes extracting and storing text and metadata on a distributed computer network.

7. The system of claim 1, wherein the at least one processor is further configured to load one or more batches of processed first documents into a vector repository.

8. The system of claim 1, wherein the first threshold is between 0.5 and 1.

9. The system of claim 8, wherein the first threshold is 0.85.

10. The system of claim 1, wherein the second threshold is between 50 and 150.

11. The system of claim 10, wherein the second threshold is 100.

12. The system of claim 1, wherein the third threshold is between 5 and 10.

13. The system of claim 12, wherein the third threshold is 6.

14-24. (canceled)

25. The system of claim 6, wherein the at least one processor is further configured to extract text and metadata using at least one of:
natural language processing;
optical character recognition;
a KNN algorithm; or
an ANN algorithm.

26. The system of claim 1, wherein cleaning further includes:
removing malicious scripts;
removing personal identifying information; or
removing malware from the first document and the second document.

27. The system of claim 1, wherein tokenizing further includes substituting a sensitive data element with a non-sensitive data element using at least one of:
word tokenization, character tokenization, or subword tokenization.

28. A method comprising:
retrieving, from a first source, a first document;
retrieving, from a second source, a second document;
processing the first document and the second document, wherein processing includes cleaning, tokenizing, and vectorizing each of the first document and the second document;
determining a cosine similarity between a first set of numbers and a second set of numbers, the first set of numbers corresponding to one or more sentences in the first document and the second set of numbers corresponding to one or more sentences in the second document, wherein each number in the first set of numbers corresponds to a word in the first document and each number in the second set of numbers corresponds to a word in the second document;
determining whether the cosine similarity exceeds a first threshold;
determining, based on the cosine similarity, a number of words in common between the first document and the second document;
determining whether the number of words in common exceeds a second threshold;
determining, based on the cosine similarity, a number of sentences in common between the first document and the second document;
determining whether the number of sentences in common exceeds a third threshold; and
responsive to a determination that the cosine similarity exceeds the first threshold, the number of words in common exceeds the second threshold, or the number of sentences in common exceeds the third threshold:
setting a flag that indicates that the second document is a duplicate.

29. The method of claim 28, further including iterating the processing, determining, and flag setting steps for each of a plurality of documents retrieved from the second source, until the second source no longer contains any documents to process.

30. A non-transitory computer readable medium having stored instructions, which when executed, cause at least one processor to perform instructions comprising:
retrieving, from a first source, a first document;
retrieving, from a second source, a second document;
processing the first document and the second document, wherein processing includes cleaning, tokenizing, and vectorizing each of the first document and the second document;
determining a cosine similarity between a first set of numbers and a second set of numbers, the first set of numbers corresponding to one or more sentences in the first document and the second set of numbers corresponding to one or more sentences in the second document, wherein each number in the first set of numbers corresponds to a word in the first document and each number in the second set of numbers corresponds to a word in the second document;
determining whether the cosine similarity exceeds a first threshold;
determining, based on the cosine similarity, a number of words in common between the first document and the second document;
determining whether the number of words in common exceeds a second threshold;
determining, based on the cosine similarity, a number of sentences in common between the first document and the second document;
determining whether the number of sentences in common exceeds a third threshold; and
responsive to a determination that the cosine similarity exceeds the first threshold, the number of words in common exceeds the second threshold, or the number of sentences in common exceeds the third threshold:
setting a flag that indicates that the second document is a duplicate.

31. The non-transitory computer readable medium of claim 30, wherein the at least one processor is further configured to:
iterate the processing, determining, and flag setting steps for each of a plurality of documents retrieved from the second source, until the second source no longer contains any documents to process.
